(19) United States
(12) Patent Application Publication
(10) Pub. No.: US 2024/0365692 A1
(43) Pub. Date: Nov. 7, 2024

(54) WIDTH-VARIABLE TILLAGE DEVICE

(71) Applicant: TREFFLER MASCHINENBAU GMBH & CO. KG, Pöttmes-Echsheim (DE)

(72) Inventor: Engelbert Rath, JR., Pfatter (DE)

(21) Appl. No.: 18/501,165

(22) Filed: Nov. 3, 2023

(30) Foreign Application Priority Data
May 3, 2023 (DE) 202023102385.1

(51) Int. Cl. A01B 33/08; A01B 33/12

(52) U.S. Cl. CPC A01B 33/087; A01B 33/12

(57) ABSTRACT

A width-variable tillage device is provided with a frame and a leading four-bar first guide mechanism connected to the frame. The first guide mechanism has a depth guide element which regulates a height of the first guide mechanism above the ground, and an actuator which actuates the height of the first guide mechanism between a working position close to the ground and an elevated position remote from the ground. The tillage device further has a trailing second guide mechanism connected to the frame and having at least one tool for tillage, and a connecting member which connects the first and second guide mechanisms such that the second guide mechanism follows the height of the first guide mechanism and can be moved in a transverse direction. Furthermore, the tillage device has a width adjustment unit which can adjust a distance in the transverse direction between the first and second guide mechanisms.

### TECHNICAL FIELD OF THE INVENTION

The present invention relates to a width-variable tillage device.

### BACKGROUND

Various tillage devices are known in the prior art. A tillage device is an agricultural device suitable for tilling and sowing, i.e., working the soil or seeds, of crops in agricultural farming. This device is used, inter alia, as a care device for growing potatoes, corn, beans, lettuce, rapeseed, general vegetables, and cereals, which are preferably sown in rows. An example of a tillage device is a harrow disclosed in DE 39 00 100 A1, in which the soil is tilled with a constant tine pressure.

The tillage device is moved in a direction of travel with the aid of a towing vehicle, for example a tractor, in order to till the soil thereunder with situation-dependent tools, for example tines, cutting discs or hoes. The tillage can comprise both tilling of plant rows planted in the soil and tilling of the soil beside the plant rows.

Depending on the intended use, the tool can be height-adjustable and/or pivotable relative to the frame and can be provided with a depth-guiding element such as, for example, a roller, so that the penetration depth into the uneven soil to be tilled remains constant at a set level (height regulation). Furthermore, approaches for a sectional elevation are known, in which individual tools are elevated in order to switch off partial widths of the tilling (individual tool rows) at the edge of the field, at the headland or in the event of obstacles and thus to avoid overlaps.

In order to ensure a sufficient elevation height, Applicant references DE 20 2021 102 484 U1 which proposes providing a four-bar linkage as a guide mechanism which can guide a tool along a predetermined guide curve. According to DE 20 2021 102 484 U1, a four-bar linkage guide mechanism comprising four bars or links with four joints arranged therebetween is provided. By means of this basic structure, a guide mechanism is implemented which can guide a tool along the elevation direction. The terms “guide mechanism”, “four-bar [linkage]”, “articulated” and “depth guide element” from DE 20 2021 102 484 U1 are used analogously in the present application, and therefore their definitions and all statements directly related thereto in [0006] to [0008] and [0050] to [0056] of DE 20 2021 102 484 U1 are expressly incorporated herein by reference.

Since the tillage device has a certain width, it can till a surface in the form of a strip with a constant or variable width. The width of the strip is conventionally determined by the distance between the outermost tools which are arranged in one or more tool rows in the transverse direction. In order to make the width of the strip variable rather than constant, a device is known from European patent application EP23157298.3, filed on Feb. 17, 2023, which allows the elevation of a part of the tools. For this purpose, EP23157298.3 proposes switching on and off outer tool rows by elevation in order to set the partial width and/or a tilling width beside the plant rows.

The setting steps of the partial widths and of the tilling width beside the plant rows are determined in the setup stage according to EP23157298.3 by the distance between the tools, which preferably corresponds to the distance between the plant rows or a mean fraction thereof. For example, the number of tools per plant row is three, so that the distance between the tools is one third of the plant row distance. Accordingly, the precision or resolution of the width adjustment is limited by the arrangement density of the tools. If, however, such distances occur between the plant rows or tilling widths beside the plant rows which are lower than the resolution, i.e., if the distance between the tools has to be reduced, a retooling is necessary in the device of EP23157298.3 in order to realign the tool rows. Accordingly, the precision of the setting is limited, and the number of use cases which can be covered without retooling times is limited by the distance between the tools.

### SUMMARY OF THE INVENTION

The invention is based on the object of providing a tillage device which covers a large number of different use cases without retooling times and with high precision.

This object is achieved by a tillage device according to claim 1 or a tillage device according to claim 2. Advantageous further developments are the subject-matter of the dependent claims.

In one aspect of the invention, a width-variable tillage device is provided with a frame to be pulled behind a towing vehicle and a first guide mechanism which is configured as a leading four-bar guide mechanism and is connected to the frame. The first guide mechanism has a depth guide element which travels on the ground in order to regulate a height of the first guide mechanism above the ground, and an actuator which actuates the height of the first guide mechanism between a working position close to the ground, in which the first guide mechanism is guided by the depth guide element, and an elevated position remote from the ground, in which the first guide mechanism is not guided by the depth guide element. The width-variable tillage device further has a second guide mechanism which is configured as a trailing guide mechanism, is connected to the frame and has at least one tool for tillage, and a connecting member which connects the first guide mechanism and the second guide mechanism such that the second guide mechanism follows the height of the first guide mechanism and the second guide mechanism can be moved, preferably displaced, in a transverse direction which extends transversely to the direction of travel of the frame. Furthermore, the width-variable tillage device has a width adjustment unit which can adjust a distance in the transverse direction between the first guide mechanism and the second guide mechanism.

By means of the above-described structure, the width-variable tillage device according to the invention is capable of adjusting the distance between the first guide mechanism and the second guide mechanism in a short time, steplessly and with high precision (width adjustment). As a result, the width-variable tillage device can react to changes both of the distance between the plant rows and of the tilling width beside the plant rows without retooling times. Even if only a single tool is provided on the second guide mechanism, the width-variable tillage device according to the invention can adapt this tool to a relative offset between the plant row or tilling location and the tillage device, which allows a tilling change over or between the plant rows, depending on the growth stage.

Accordingly, the use spectrum is very broad, so that the width-variable tillage device according to the invention can cover a large number of different use cases.

In addition, the first guide mechanism is configured as a four-bar guide mechanism and has the depth guide element and the actuator. Thus, the first guide mechanism can achieve an optimal elevation height and optimally guide its height over the ground. Furthermore, the second guide mechanism is connected by the connecting member to the first guide mechanism and follows its height. For this reason, the first guide mechanism which guides the height is referred to as the leading guide mechanism, and the second guide mechanism which follows the height of the first guide mechanism is referred to as the trailing guide mechanism. By the trailing of the second guide mechanism, the correct penetration depth of the tool which is provided on the second guide mechanism can be ensured with a simple configuration without having to provide an additional depth guide element. Likewise, the second guide mechanism can be elevated without a separate actuator, which further simplifies the configuration.

Since the first guide mechanism is configured as a leading four-bar guide mechanism and the second guide mechanism follows or trails it, it is furthermore not necessary to configure the second guide mechanism as a four-bar guide mechanism. Instead, preferably a single link, for example a simple pivot rod, which substantially corresponds to the lower link of the four-bar guide mechanism, can be used as the second guide mechanism in order to further simplify the configuration. Accordingly, a simple, passive configuration is provided in which only the first guide mechanism has a depth guide element for height regulation and/or an actuator for the elevation.

In another aspect of the invention, a width-variable tillage device according to the invention has a frame to be pulled behind a towing vehicle, a first guide mechanism which is configured as a four-bar guide mechanism, and a second guide mechanism which is configured as a four-bar guide mechanism and has at least one tool for tillage. Each of the first guide mechanism and the second guide mechanism is connected to the frame and has a depth guide element which travels on the ground in order to regulate a height of the respective guide mechanism above the ground. At least one of the first guide mechanism and the second guide mechanism has an actuator which actuates the height of the respective guide mechanism between a working position close to the ground, in which the respective guide mechanism is guided by its depth guide element, and an elevated position remote from the ground, in which the respective guide mechanism is not guided by its depth guide element. Furthermore, the width-variable tillage device has a width adjustment unit which can adjust a distance in a transverse direction which extends transversely to the direction of travel of the frame between the first guide mechanism and the second guide mechanism.

By means of the above-described structure, the width-variable tillage device according to the invention is capable of adjusting the distance between the first guide mechanism and the second guide mechanism in a short time, steplessly and with high precision. As a result, the width-variable tillage device can react to changes both of the distance between the plant rows and of the tilling width beside the plant rows without retooling times. Even if only a single tool is provided on the second guide mechanism, the width-variable tillage device according to the invention can adapt this tool to a relative offset between the plant row or tilling location and the tillage device, which allows a tilling change over or between the plant rows, depending on the growth stage of the crops.

Accordingly, the use spectrum is very broad, so that the width-variable tillage device according to the invention can cover a large number of different use cases.

Furthermore, since both the first guide mechanism and the second guide mechanism are each four-bar guide mechanisms each with its own depth guide element, an optimal height regulation can be achieved. Independently of this, the four-bar guide mechanisms can be provided as required with actuators for the elevation.

Preferably, the first guide mechanism is connected to the frame such that it is not movable, preferably not displaceable, in the transverse direction relative to the frame.

There are use cases in which the offset to the plant row (in the case of a single first guide mechanism) and/or the distance between the plant rows (in the case of a plurality of first guide mechanisms) is not variable. In these cases, it is not necessary to adjust the first guide mechanism in the transverse direction. Thus, advantageously, a first guide mechanism can be provided for each plant row directly above the plant row and at least one second guide mechanism can be provided beside the plant row. Since the location of the plant row(s) relative to the tillage device is constant, the first guide mechanism can be provided in a stationary manner, and the second guide mechanism can adjust the tilling width beside the plant rows. Accordingly, the structure is simplified, thereby improving cost-efficiency.

Alternatively, the first guide mechanism is connected to the frame such that it is movable, preferably displaceable, in the transverse direction relative to the frame.

Thus, an offset to the plant row in the transverse direction can be compensated. Moreover, if a plurality of first guide mechanisms are provided, the distance between the plant rows can also be adjusted with high precision.

Preferably, the width adjustment unit changes the distance in the transverse direction between the first guide mechanism and the second guide mechanism uniformly relative to the frame.

The aforementioned structure is suitable if the tilling with the first and second guide mechanisms takes place only beside the plant row and not above the plant row. In this context, “uniformly” means that a fixed reference point can be defined on the frame which lies between the first guide mechanism and the second guide mechanism and relative to which the distances to the first guide mechanism and the second guide mechanism can be changed in the ratio of 1:1.

Preferably, the second guide mechanism is a four-bar guide mechanism and has a/the depth guide element and an actuator which actuates the height of the second guide mechanism between its working position and its elevated position.

Accordingly, the second guide mechanism can be elevated independently of the first guide mechanism, as a result of which the use spectrum is further increased. Moreover, the height regulation and the guiding of the tool along the predetermined guide curve are improved.

Alternatively, the first guide mechanism is a leading guide mechanism which has the actuator, and the second guide mechanism is a trailing guide mechanism which is provided with a connecting member which connects the first guide mechanism and the second guide mechanism such that the second guide mechanism follows the height of the first guide mechanism and the second guide mechanism can be moved, preferably displaced, in a transverse direction which extends transversely to the direction of travel of the frame.

As described above, by the trailing of the second guide mechanism, the correct penetration depth of the tool which is provided on the second guide mechanism can be ensured with a simple configuration without having to provide an additional depth guide element. Likewise, the second guide mechanism can be elevated without a separate actuator, which further simplifies the configuration. In such a case, it can furthermore be advantageous to provide a vertical play between the first guide mechanism and the second guide mechanism so that the second guide mechanism can follow the height regulation of its depth guide element without feedback to the first guide mechanism and can nevertheless be elevated by the first guide mechanism.

Preferably, the connecting member can interrupt the connection for transmitting forces in the vertical direction between the first guide mechanism and the second guide mechanism. Accordingly, the second guide mechanism can be decoupled from the first guide mechanism so that the height regulation and the elevation can take place separately in order to further increase the use spectrum.

Preferably, the width-variable tillage device has at least one further second guide mechanism. As a result, the use spectrum is further increased. This structure is particularly advantageous in combination with the connecting member and the trailing configuration of the second guide mechanism, as a result of which the structure is further simplified.

Preferably, all second guide mechanisms are distributed on both sides of the first guide mechanism in the transverse direction. In this way, symmetrical tillage beside the plant rows is achieved. In addition, the use spectrum is further increased. For example, the first four-bar guide mechanism can be provided with a tool which tills the plant row, and the second guide mechanisms can be provided with tools which till the soil to the left and right beside the plant row. This structure is particularly advantageous if an even number of second guide mechanisms is provided and distributed uniformly.

Alternatively, all second guide mechanisms are arranged on one side of the first guide mechanism in the transverse direction. In this way, the structure is further simplified, and the use spectrum is further increased. For example, the first guide mechanism and the second guide mechanisms can each have tools for tilling a plant row, so that all first and second guide mechanisms each till one plant row.

Preferably, the connecting member is an angle divider which has two bar members, one of which is articulated to the first guide mechanism and the other of which is articulated to the second guide mechanism, and a central part to which the two bar members are articulated. In this way, a simple, cost-effective configuration is achieved. The central part can be, for example, a plate which has two bolts in order to articulate the bar members. The bar members are preferably connected via a toothing such that an imaginary line, which is normal to the central part in the center of the central part, bisects the angle between the bar members. In this way, the stability of the force transmission is further improved, since the force transmission takes place symmetrically from one bar member to the central part and from the central part to the other bar member. Alternatively, the central part itself can be a bolt, so that the bar members are mutually articulated to one another.

Preferably, the bar members have their articulation axes and their width in the vertical direction. In other words, the bar members are preferably pivotable about axes which run vertically. In this way, the vertical trailing forces for height regulation and for elevation can be transmitted with minimal use of material, as a result of which the structure is simplified, and a cost saving is achieved.

Alternatively, the bar members have their articulation axes in the horizontal direction. For example, the bar members can be part of a four-bar linkage which transmits vertical trailing forces. In this way, the trailing precision is improved.

Preferably, the connecting member is a linearly adjustable mechanism. In this way, the structure is simplified. Preferably, the linearly adjustable mechanism is configured as a telescopic tube. This is a particularly simple and cost-effective possibility of providing a linearly adjustable mechanism.

Preferably, the linearly adjustable mechanism is configured as a linear actuator which adjusts the distance in the transverse direction and transmits forces in the vertical direction. Accordingly, the connecting member is at the same time an actuator which can adjust the distance between the first guide mechanism and the second guide mechanism, so that the connecting member is a part of the width adjustment unit or forms a functional unit with the width adjustment unit. In this way, the number of components is reduced, and the structure is further simplified.

Preferably, the width adjustment unit has a slide rod to which the second guide mechanism is articulated, and/or has a slide rod to which the first guide mechanism is articulated. The slide rod is a rod which runs in the transverse direction and has any cross section to which the respective guide mechanism is connected such that it can pivot upward and downward (i.e., is articulated). In this way, a simple and stable structure is achieved.

Preferably, a displacement of the slide rod in the transverse direction results in a movement, preferably displacement, of the associated guide mechanism in the transverse direction, and the slide rod is actuated via a slide actuator. Accordingly, the slide actuator can displace the associated guide mechanism in the transverse direction via the slide rod. In other words, the guide mechanism follows the slide rod in the transverse direction, whereby a simple and robust structure is implemented. For example, if the first guide mechanism is stationary and the second guide mechanism is articulated to the slide rod, the slide actuator can adjust the distance between the first guide mechanism and the second guide mechanism. Accordingly, the slide rod and the slide actuator are parts of the width adjustment unit.

Preferably, a plurality of second guide mechanisms is connected to a common slide rod, so that the plurality of second guide mechanisms are displaced together when the slide rod is actuated. In this way, the structure is further simplified, and the number of actuators to be provided is reduced.

Alternatively, the second guide mechanism is slidably supported on the slide rod, so that it is movable, preferably displaceable, in the transverse direction, and the second guide mechanism is actuated in the transverse direction via a slide actuator. Accordingly, the slide rod is not displaced together with the second guide mechanism. Consequently, smaller forces are required for adjustment, which enables the use of a smaller slide actuator and thus cost saving. In addition, this structure offers additional flexibility since further components can be attached to the slide rod without being impaired by the width adjustment.

Preferably, a plurality of second guide mechanisms is actuated by a common slide actuator. In this way, the structure is further simplified, and the number of actuators to be provided is reduced.

Preferably, the width-variable tillage device further has a guide rod on which the first guide mechanism and/or the second guide mechanism is/are slidably supported, so that the guide rod is not displaced in the transverse direction when the guide mechanism supported thereon is displaced in the transverse direction. Accordingly, the stability of the entire structure is further improved. Since the guide rod does not have to be displaced in the transverse direction, it offers an improvement of stability without substantially increasing the complexity.

Preferably, the second guide mechanism has a reinforcing strut, one end of which is articulated or connected to the slide rod and the other end of which is articulated or connected to the second guide mechanism. In this way, the second guide mechanism can absorb high forces in the transverse direction with a simple structure. Accordingly, the stability during the adjustment and the lateral guiding of the tool are improved.

Preferably, the actuator of the first guide mechanism and/or the actuator of the second guide mechanism and/or the slide actuator is/are actuated hydraulically. Very high excavation and adjustment forces can be applied by a hydraulic actuator, which is advantageous in particular in the case of heavy tools. In addition, hydraulic actuators have a small space requirement, whereby a space-saving structure is possible. Furthermore, a hydraulic pressure line is often already present on towing machines such as tractors, so that the hydraulic actuator does not require a separate pump or other device for pressure generation. In such a case, a cost-effective structure is possible.

Alternatively, or additionally, the actuator of the first guide mechanism and/or the actuator of the second guide mechanism and/or the slide actuator is/are actuated electromechanically. In this case, the structure is simplified to the effect that no device is required for pressure generation, which furthermore reduces the space requirement. Moreover, the precision of the adjustment is improved.

Alternatively, or additionally, the actuator of the first guide mechanism and/or the actuator of the second guide mechanism and/or the slide actuator is/are actuated manually. In this way, a very simple and cost-effective structure is achieved. A manual actuation is particularly advantageous if no adjustment is required during travel.

Preferably, the first guide mechanism also has at least one tool for tillage. In this way, the number of tools which simultaneously till the soil is increased, as a result of which the productivity is increased.

Preferably, the tool or at least one of the tools is a cutting disc. Alternatively or additionally, the tool or at least one of the tools is a hoe, for example a goosefoot sweep. Alternatively, or additionally, the tool or at least one of the tools is a tine. These types of tools benefit to a particularly high degree from the width adjustment according to the invention. If at least one of the tools is a cutting disc, it is even more preferred for the use spectrum if a working angle of the cutting disc is adjustable.

Preferably, the depth guide element is a support wheel. In this way, a simple structure is ensured. Furthermore, the support wheel is advantageous due to its low rolling resistance in particular with regard to the fuel consumption of the towing vehicle. Alternatively, the depth guide element is a skid. In this way, a simple, robust, and maintenance-free structure is ensured.

### BRIEF DESCRIPTION OF THE DRAWINGS

FIG. 1 is a perspective view of a width-variable tillage device according to a first exemplary embodiment, shown in an elevated position.

FIG. 2 is a perspective view of the width-variable tillage device according to the first embodiment, shown in a working position.

FIG. 3 is a perspective view of the width-variable tillage device according to the first embodiment, shown at a maximum tilling width.

FIG. 4 is a perspective view of the width-variable tillage device according to the first embodiment, shown at a minimum tilling width.

FIG. 5 is a diagram schematically showing the width-variable tillage device according to the first embodiment.

FIG. 6 is a diagram of a width-variable tillage device according to a second exemplary embodiment, schematically shown at a minimum tilling width.

FIG. 7 is a diagram of the width-variable tillage device according to the second embodiment, schematically shown at a medium tilling width.

FIG. 8 is a diagram of the width-variable tillage device according to the second embodiment, schematically shown at a maximum tilling width.

FIG. 9 is a diagram of a width-variable tillage device according to a modification of the second embodiment, schematically shown at a maximum tilling width.

### DETAILED DESCRIPTION OF THE EMBODIMENTS

### First Exemplary Embodiment

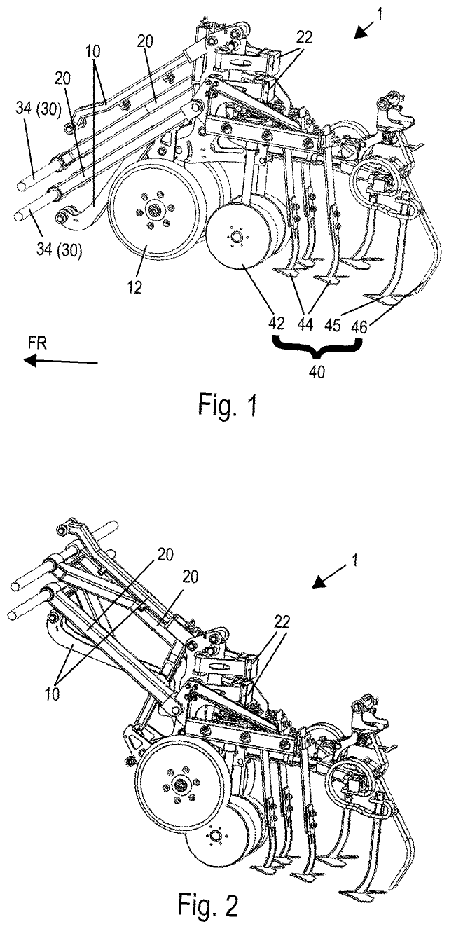

FIGS. 1 to 5 show a width-variable tillage device 1 according to a first exemplary embodiment of the invention.

With reference to FIGS. 1 and 2, the basic structure of the width-variable tillage device 1 is described. FIG. 1 shows the tillage device 1 in an elevated position, viewed from a left side, and FIG. 2 shows the tillage device 1 in a working position, viewed from the left side.

The tillage device 1 has a frame (not shown) which is pulled behind a towing vehicle (not shown). The pulling direction is referred to as the direction of travel FR and is indicated in FIG. 1. The frame can be pulled in the form of a trailer or can be directly attached to the towing vehicle.

In the present exemplary embodiment, a first guide mechanism 10 and two second guide mechanisms 20 are attached to the frame. The guide mechanisms 10, 20 serve for guiding tools 40 along a guide curve which extends substantially in an elevation direction. A lowering of the tools 40 is the change from the elevated position of FIG. 1 into the working position of FIG. 2; an elevating of the tools 40 is the reverse change from the working position into the elevated position.

In the present exemplary embodiment, the first guide mechanism 10 is configured as a four-bar guide mechanism (see DE 20 2021 102 484 U1). The first guide mechanism 10 has an actuator (not shown or not identified depending on the figure), by means of which it can be lowered or elevated in order to implement an elevation function. In addition, the first guide mechanism 10 has a depth guide element 12 which is configured as a support wheel, but other types of depth guidance are also possible, for example a skid or a runner. By means of the depth guide element 12, the height of the first guide mechanism 10 above the ground is regulated, which is referred to as height regulation. Since, in the present exemplary embodiment, the first guide mechanism 10 is a four-bar linkage which has both the elevation function and the height regulation, the first guide mechanism 10 is thus a leading four-bar guide mechanism.

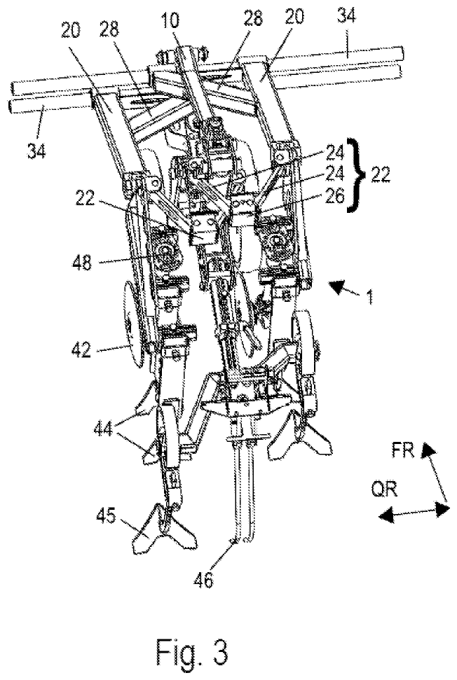

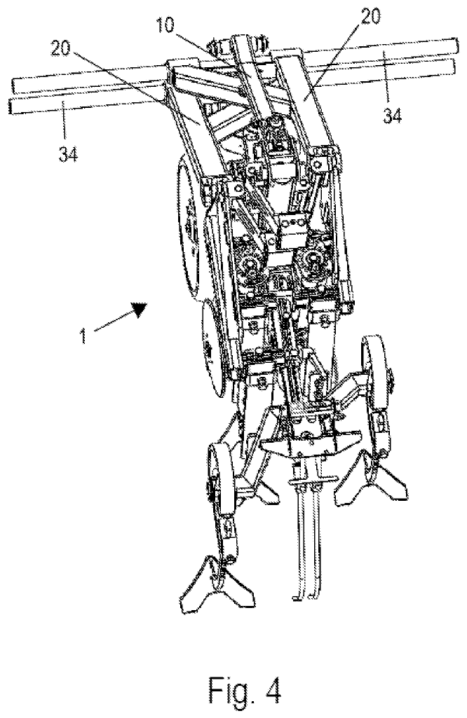

In the present exemplary embodiment, the second guide mechanism 20 is configured as a trailing guide mechanism. For the purpose of the trailing function, in the present exemplary embodiment, a connecting member 22 which is described in more detail later with reference to FIGS. 3 and 4 is provided. The connecting member 22 transmits forces in the vertical direction between the first guide mechanism 10 and the second guide mechanism 20. Thus, the second guide mechanism 20 follows both the lowering or elevating and the height regulation of the first guide mechanism 10, which is referred to as trailing. Since the second guide mechanism 20 trails the first guide mechanism 10, it is not necessary to configure the second guide mechanism 20 as an actuatable four-bar linkage, and the depth guide element 12 can also be omitted. Accordingly, in the present exemplary embodiment, the second guide mechanism 20 is configured as a pivot rod which is articulated to the frame via an associated slide rod 34. The slide rod 34 is part of a width adjustment unit 30 and is described later with reference to FIGS. 3 and 4.

In the present exemplary embodiment, the tools 40 comprise a cutting disc 42 and two hoes 44. These tools 42, 44 are each attached to the two second guide mechanisms 20. The cutting disc 42 is provided with an adjustment device 48 (visible in FIG. 3), so that the working angle of the cutting disc 42 is adjustable. In addition, two tines 46, which are attached centrally to the first guide mechanism 10, and two further hoes 45 are provided, which are attached to the first guide mechanism 10 to the left and right thereof. In the present exemplary embodiment, all hoes 44, 45 are configured as goosefoot sweeps. However, the selection of the tools and the distribution thereof between the guide mechanisms 10, 20 is not limited to the aforementioned, any suitable tool for tilling can be used and suitably attached to the first guide mechanism 10 and/or the second guide mechanism 20.

With reference to FIGS. 3 and 4, the width adjustment of the tillage device 1 according to the first embodiment is described. FIG. 3 shows the tillage device 1 at a maximum tilling width, viewed obliquely from above, and FIG. 4 shows the tillage device 1 at a minimum tilling width, viewed obliquely from above.

The first guide mechanism 10 is attached in a stationary manner with respect to a transverse direction QR which extends perpendicularly to the direction of travel FR (see FIG. 3). The second guide mechanism 20 is attached displaceably with respect to the transverse direction QR. More specifically, each of the two second guide mechanisms 20 is attached to an associated slide rod 34 such that the respective second guide mechanism 20 is displaced together with the slide rod 34 in the transverse direction QR when the slide rod 34 is actuated in the transverse direction QR by a slide actuator (not shown). Accordingly, the distance between the first guide mechanism 10 and the respective second guide mechanisms 20 in the transverse direction QR is changed by means of the slide actuator and the slide rod 34. As a result, a width adjustment takes place so that the tillage device 1 of the present exemplary embodiment is a width-variable tillage device 1. Thus, in the present exemplary embodiment, the slide actuator and the slide rod 34 form a width adjustment unit 30.

With reference to FIG. 3, in the present exemplary embodiment, the left second guide mechanism 20 is attached to a lower slide rod 34, and the right second guide mechanism 20 is attached to an upper slide rod 34. In addition, each second guide mechanism 20 has a reinforcing strut 28 for better absorption of the forces in the transverse direction QR. In the present exemplary embodiment, the two second guide mechanisms 20 can be actuated independently of one another; furthermore, further second guide mechanisms 20 can also be provided on each slide rod 34. An arrangement is also possible in which all second guide mechanisms 20 are arranged on the same side of the first guide mechanism 10 in the transverse direction QR, for example on the left side in FIG. 3. Furthermore, it is possible to slidably attach the second guide mechanism 20 to the respective slide rod 34 and to actuate the second guide mechanism 20 directly with the slide actuator. A simultaneous actuation of a plurality of second guide mechanisms 20 with a common slide rod or slide actuator is possible.

Each second guide mechanism 20 is connected via the associated connecting member 22 to the first guide mechanism 10 in order to follow (trail) it. For the width adjustment, it is furthermore necessary that the connecting member 22 enables a movement or displacement of the second guide mechanism 20 relative to the first guide mechanism 10 in the transverse direction QR. In the present exemplary embodiment, this is implemented by an angle divider. More specifically, the angle divider (the connecting member 22) has two bar members 24 which connect the first guide mechanism 10 and the second guide mechanism 20 to a central part 26. In the present exemplary embodiment, the central part 26 is a plate with two vertically extending bolts but can also be a single vertically extending bolt. The bar members 24 are connected via a toothing such that an imaginary line, which is normal to the central part 26 in the center of the central part 26, bisects the angle between the bar members 24. Accordingly, the bar members 24 always have the same angle with respect to the central part 26 (cf. FIGS. 3 and 4). In the present case, the bar members 24 are also articulated to the corresponding guide mechanism 10, 20 with vertically extending bolts and have their width in the vertical direction. Accordingly, the angle divider as the connecting member 22 is capable of optimally transmitting forces in the vertical direction and at the same time of enabling the relative movement in the transverse direction QR between the first guide mechanism 10 and the second guide mechanism 20 with a minimum resistance.

The connecting member 22 is not limited to the angle divider and can have any configuration in which the vertical forces are transmitted and at the same time the horizontal width adjustment is enabled. For example, a four-bar linkage, a telescopic tube, a linearly adjustable mechanism, or a linear actuator can be used. In the case of the linear actuator, the latter can assume the function of the width adjustment unit 30 and adjust the distance between the first guide mechanism 10 and the second guide mechanism 20. Depending on the application, it can also be suitable to be able to interrupt the force transmission in the transverse direction QR, for example by releasable bolts or by coupling elements.

With the tillage device 1 of the first embodiment, the width adjustment between the maximum tilling width shown in FIG. 3 and the minimum tilling width shown in FIG. 4 is possible steplessly. In the first embodiment, the width adjustment unit 30 has the slide rod 34 and the slide actuator, wherein the connecting member 22 ensures the trailing function and at the same time enables the width adjustment. In this way, the advantages described in the summary of the invention are achieved with the tillage device 1 of the first embodiment.

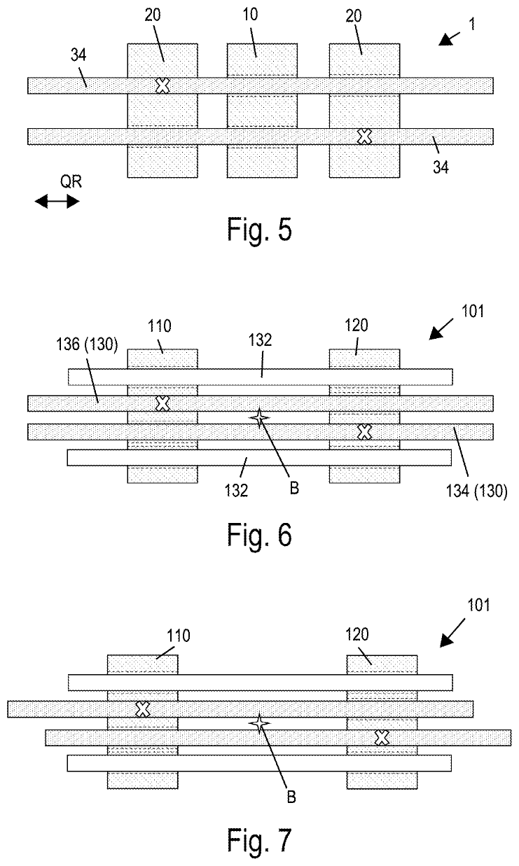

The tillage device 1 of the first embodiment is schematically summarized in FIG. 5, viewed in the direction of a rear (i.e., from the front). The first guide mechanism 10 is arranged centrally, and one second guide mechanism 20 each is arranged to the left and right thereof. An upper slide rod 34 is connected to one (the left one in FIG. 5) of the second guide mechanisms 20, which is identified by an X. The upper slide rod 34 is not connected to the first guide mechanism 10 and to the other (the left one) of the second guide mechanisms 20, which is identified by dashed lines. Likewise, the lower slide rod 34 is only connected to the one (the right one in FIG. 5) of the second guide mechanisms 20.

### Second Exemplary Embodiment

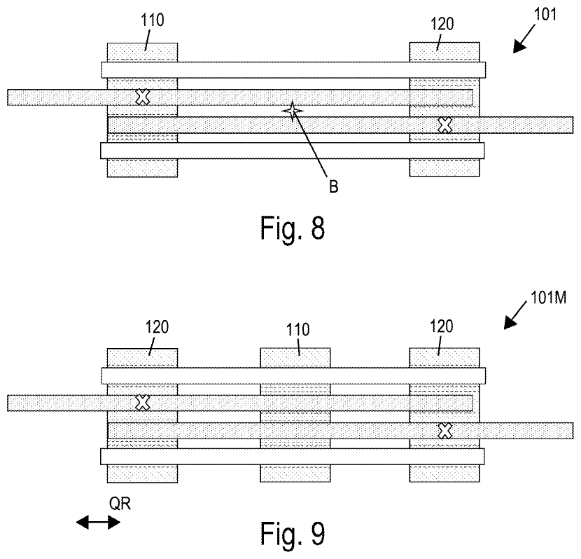

FIGS. 6 to 8 show a width-variable tillage device 101 according to a second exemplary embodiment of the invention. The representation takes place analogously to that of FIG. 5 schematically (not true to scale), since the structural details correspond to those of the first exemplary embodiment, unless indicated otherwise.

FIG. 6 shows the tillage device 101 at a minimum tilling width. In the present exemplary embodiment, both a first guide mechanism 110 and a second guide mechanism 120 are configured as four-bar guide mechanisms. In the present case, each guide mechanism 110, 120 has a depth guide element (not shown) so that the height regulation for each guide mechanism 110, 120 takes place independently. In the present exemplary embodiment, the elevation function is implemented with a respective actuator (not shown) for each guide mechanism 110, 120. However, it is easily possible to use the connecting member 22 of the first exemplary embodiment instead and to implement a configuration with a leading first guide mechanism 110 and a trailing second guide mechanism 120.

The tillage device 101 of the present exemplary embodiment is provided with a width adjustment unit 130 which has a slide rod 136 of the first guide mechanism 110, a slide rod 134 of the second guide mechanism 120 and two guide rods 132.

The slide rod 134 of the second guide mechanism 120 according to the second exemplary embodiment corresponds to the slide rod 34 according to the first exemplary embodiment and is connected to the second guide mechanism 120 in order to actuate the latter in the transverse direction QR. In the same way, slide rod 136 is connected to the first guide mechanism 110 in order to actuate the latter in the transverse direction QR. The width adjustment of the guide mechanisms 110, 120 takes place in each case via a slide actuator (not shown) which actuates the slide rod 136, 134 associated with the respective guide mechanism 110, 120 in order to adjust the respective guide mechanism 110, 120 in the width direction (transverse direction QR). Thus, both guide mechanisms 110, 120 are displaceable in the transverse direction QR. In addition, the two guide rods 132 are provided on which both guide mechanisms 110, 120 are slidably supported, i.e., do not absorb forces in the transverse direction QR, but are supported in the direction of travel FR and the vertical direction. Accordingly, the optional guide rods 132 improve the stability. However, the supporting effect of the guide rods 132 can be implemented completely or partially by the slide rods and/or other supporting devices or can be omitted entirely.

In the present exemplary embodiment, the guide mechanisms 110, 120 are adjusted uniformly so that both guide mechanisms 110, 120 move away in opposite directions by equal distances from an imaginary reference point B located approximately centrally therebetween. The uniform adjustment can be seen clearly when viewing FIGS. 6 to 8 together. However, it is also possible to actuate the first guide mechanism 110 and the second guide mechanism 120 non-uniformly and/or in the same direction instead of in opposite directions. For example, the first guide mechanism 110 and the second guide mechanism 120 can be actuated to the left by the same amount in order to compensate for an offset, e.g., in order to change from tilling the plant row to tilling beside the plant row.

The tillage device 101 of the second embodiment achieves the same advantages as those of the tillage device 1 of the first embodiment.

### Modifications

FIG. 9 shows a width-variable tillage device 101M according to a modification of the second embodiment. While in the second embodiment the first guide mechanism 110 and the second guide mechanism 120 are displaceable in the transverse direction QR, in this modification a first guide mechanism 110 is provided in a stationary manner with respect to the transverse direction QR, and on both sides thereof two second guide mechanisms 120 are provided which are actuated uniformly. The actuation of the two second guide mechanisms 120 is analogous to the actuation of the first guide mechanism 110 and of the second guide mechanism 120 of the second embodiment, and therefore this is not described in more detail. The modification can be implemented both in the trailing version and in the version in which each guide mechanism has an elevation function and a height regulation.

In the preceding description guide mechanisms have been described which are displaceable in the transverse direction QR. However, the present invention is not limited thereto, and the guide mechanisms can execute a different movement, for example a pivoting movement which has a displacement component in the transverse direction QR.

In the preceding description a plurality of actuators has been described, namely the actuator of the first and/or second guide mechanism and the slide actuator. The type of actuation of all actuators is not limited and can suitably take place hydraulically, electromechanically, or manually, as a result of which the advantages described in the summary of the invention are achieved.

The present invention is preferably used in agriculture for tilling soil on productive land.

A width-variable tillage device is provided with a frame and a leading four-bar first guide mechanism connected to the frame. The first guide mechanism has a depth guide element which regulates a height of the first guide mechanism above the ground, and an actuator which actuates the height of the first guide mechanism between a working position close to the ground and an elevated position remote from the ground. The tillage device further has a trailing second guide mechanism connected to the frame and having at least one tool for tillage, and a connecting member which connects the first and second guide mechanisms such that the second guide mechanism follows the height of the first guide mechanism and can be moved in a transverse direction. Furthermore, the tillage device has a width adjustment unit which can adjust a distance in the transverse direction between the first and second guide mechanisms.

What is claimed is:

1. Width-variable tillage device comprising:
a frame to be pulled behind a towing vehicle;
a first guide mechanism which is configured as a leading four-bar guide mechanism and is connected to the frame, and which includes:
a depth guide element which travels on the ground in order to regulate a height of the first guide mechanism above the ground, and
an actuator which actuates the height of the first guide mechanism between a working position close to the ground, in which the first guide mechanism is guided by the depth guide element, and an elevated position remote from the ground, in which the first guide mechanism is not guided by the depth guide element;
a second guide mechanism which is configured as a trailing guide mechanism, is connected to the frame and has at least one tool for tillage;
a connecting member which connects the first guide mechanism and the second guide mechanism such that (i) the second guide mechanism follows the height of the first guide mechanism and (ii) the second guide mechanism can be moved, preferably displaced, in a transverse direction (QR) which extends transversely to the direction of travel (FR) of the frame; and
a width adjustment unit which can adjust a distance in the transverse direction (QR) between the first guide mechanism and the second guide mechanism.

2. Width-variable tillage device comprising:
a frame to be pulled behind a towing vehicle;
a first guide mechanism which is configured as a four-bar guide mechanism;
a second guide mechanism which is configured as a four-bar guide mechanism and has at least one tool for tillage;
wherein each of the first guide mechanism and the second guide mechanism is connected to the frame and has a depth guide element which travels on the ground in order to regulate a height of the respective guide mechanism above the ground, and wherein
at least one of the first guide mechanism and the second guide mechanism has an actuator which actuates the height of the respective guide mechanism between a working position close to the ground, in which the respective guide mechanism is guided by its depth guide element, and an elevated position remote from the ground, in which the respective guide mechanism is not guided by its depth guide element; and
a width adjustment unit which can adjust a distance in a transverse direction (QR) which extends transversely to the direction of travel (FR) of the frame between the first guide mechanism and the second guide mechanism.

3. The width-variable tillage device according to claim 1 or 2, wherein the first guide mechanism is connected to the frame such that it is not movable, or not displaceable, in the transverse direction (QR) relative to the frame.

4. The width-variable tillage device according to claim 1 or 2, wherein the first guide mechanism is connected to the frame such that it is movable, or displaceable, in the transverse direction (QR) relative to the frame.

5. The width-variable tillage device according to claim 4, wherein the width adjustment unit changes the distance in the transverse direction (QR) between the first guide mechanism and the second guide mechanism uniformly relative to the frame.

6. The width-variable tillage device according to claim 1 or 2, wherein the second guide mechanism is a four-bar guide mechanism and has a depth guide element and an actuator which actuates the height of the second guide mechanism between its working position and its elevated position.

7. The width-variable tillage device according to claim 2, wherein
the first guide mechanism is a leading guide mechanism which has the actuator, and
the second guide mechanism is a trailing guide mechanism which is provided with a connecting member which connects the first guide mechanism and the second guide mechanism such that (i) the second guide mechanism follows the height of the first guide mechanism and (ii) the second guide mechanism can be moved, preferably displaced, in a transverse direction (QR) which extends transversely to the direction of travel (FR) of the frame.

8. The width-variable tillage device according to claim 7, wherein the connecting member can interrupt the connection for transmitting forces in the vertical direction between the first guide mechanism and the second guide mechanism.

9. The width-variable tillage device according to claim 1, wherein the connecting member can interrupt the connection for transmitting forces in the vertical direction between the first guide mechanism and the second guide mechanism.

10. The width-variable tillage device according to claim 1 or 2, further comprising at least one further second guide mechanism, preferably wherein
all second guide mechanisms are distributed on both sides of the first guide mechanism in the transverse direction (QR), or
all second guide mechanisms are arranged on one side of the first guide mechanism in the transverse direction (QR).

11. The width-variable tillage device according to claim 1 or 2, wherein the connecting member is an angle divider which has
two bar members, one of which is articulated to the first guide mechanism and the other of which is articulated to the second guide mechanism; and
a central part to which the two bar members are articulated.

12. The width-variable tillage device according to claim 11, wherein
the bar members have their articulation axes and their width in the vertical direction, or
the bar members have their articulation axes in the horizontal direction.

13. The width-variable tillage device according to claim 1 or 2, wherein the connecting member is a linearly adjustable mechanism.

14. The width-variable tillage device according to claim 13, wherein said linearly adjustable mechanism is configured as a telescopic tube or a linear actuator which adjusts the distance in the transverse direction (QR) and transmits forces in the vertical direction.

15. The width-variable tillage device according to claim 1 or 2, wherein the width adjustment unit has a slide rod to which the second guide mechanism is articulated, and/or has a slide rod to which the first guide mechanism is articulated.

16. The width-variable tillage device according to claim 15, wherein a displacement of the slide rod in the transverse direction (QR) results in a movement, preferably displacement, of the associated guide mechanism in the transverse direction (QR), and the slide rod is actuated via a slide actuator.

17. The width-variable tillage device according to claim 16, further comprising a plurality of second guide mechanisms connected to a slide rod, so that the plurality of second guide mechanisms are displaced together when the slide rod is actuated.

18. The width-variable tillage device according to claim 15, wherein the second guide mechanism is slidably supported on the slide rod, so that it is movable, preferably displaceable, in the transverse direction (QR), and the second guide mechanism is actuated in the transverse direction (QR) via a slide actuator.

19. The width-variable tillage device according to claim 18, wherein a plurality of second guide mechanisms are actuated by a common slide actuator.

20. The width-variable tillage device according to claim 15, further comprising a guide rod on which the first guide mechanism and/or the second guide mechanism is/are slidably supported, so that the guide rod is not displaced in the transverse direction (QR) when the guide mechanism supported thereon is displaced in the transverse direction (QR).

21. The width-variable tillage device according to claim 15, wherein the second guide mechanism has a reinforcing strut having a first end articulated or connected to the slide rod and a second end articulated or connected to the second guide mechanism.

22. The width-variable tillage device according to claim 1 or 2, wherein the actuator of the first guide mechanism, the actuator of the second guide mechanism and/or the slide actuator is/are actuated hydraulically, electromechanically and/or manually.

23. The width-variable tillage device according to claim 1 or 2, wherein the first guide mechanism further comprises at least one tool for tillage.

24. The width-variable tillage device according to claim 23, wherein the at least one tool for tillage is a hoe, a tine or a cutting disc.

25. The width-variable tillage device according to claim 24, wherein a working angle of the cutting disc is adjustable.

26. The width-variable tillage device according to claim 1 or 2, wherein the depth guide element is a support wheel or a skid.
